(19) United States
(12) Patent Application Publication
(10) Pub. No.: US 2024/0324564 A1
(43) Pub. Date: Oct. 3, 2024

(54) FISHING LURE

(71) Applicant: RICHARD LEVY, HASTINGS ON HUDSON, NY (US)

(72) Inventor: RICHARD LEVY, HASTINGS ON HUDSON, NY (US)

(21) Appl. No.: 18/421,518

(22) Filed: Jan. 24, 2024

Related U.S. Application Data
(60) Provisional application No. 63/449,632, filed on Mar. 3, 2023.

(51) Int. Cl. A01K 85/01; A01K 85/00

(52) U.S. Cl. CPC A01K 85/018; A01K 85/1803; A01K 85/1847; A01K 85/1841

(57) ABSTRACT

A buoyant plug-type fishing lure includes a cavity adapted to accept a variety of water dispersible materials such as freeze-dried worms, sodium-bicarbonate or chum that are intended to impart lively random motion to the lure and provide aromatic inducement for game fish to strike. Diving characteristics and buoyancy of the lure are variable depending on the lure body shape, and the material selected.

### CROSS REFERENCES TO RELATED APPLICATIONS

This Non-Provisional patent application claims benefit to U.S. Provisional Application No. 63/449,632 entitled “FISHING LURE” and having a filing date of Mar. 3, 2023.

### TECHNICAL FIELD

The invention relates generally to fishing lures and methods therefor.

### BACKGROUND

Plug-type fishing lures are long known in the art and typically include a body designed to resemble a prey fish, a flat piece of metal or plastic termed a “diving bill” at the front of the body, and one or more treble hooks mounted to the underside of the body. Typically, an experienced user may vary the depth and duration of a dive by varying the speed at which the lure is reeled through the water. Although such plug-type lures work well for their intended use, their efficacy depends on experience and practice.

It would be desirable to produce a plug-type fishing lure with a cavity designed to temporarily contain and disperse a non-toxic fish attractant when the lure is drawn through the water.

It would be further desirable if such a lure were to accept materials that by their water dispersive characteristics, alter the motion of the lure as it is moved through the water.

It would be even further desirable if such a lure were to require no special skills and would be easy to use even by inexperienced fishermen and children.

### SUMMARY

In a general example implementation according to the present invention, a plug-type fishing lure includes a body with an internal cavity adapted to contain and disperse one or more at least partially water dispersible materials placed in the cavity.

In an aspect combinable with any other aspect, apertures or passageways lead from the cavity to an exterior of the body.

In an aspect combinable with any other aspect, the body includes separable portions so that the cavity may be accessed and materials placed therein.

In an aspect combinable with any other aspect, the body includes a diving bill that may be any size, may be adjustable or may be set at any desired angle.

In an aspect combinable with any other aspect, the body may include visible apertures of any size or shape and/or partially hidden apertures.

In an aspect combinable with any other aspect, the body may be ovoid, a shape common to plug-type lures, spherical or capsule shaped.

In an aspect combinable with any other aspect, the body may include one or more fins, tails or flanges.

In an aspect combinable with any other aspect, the water dispersible material may be freeze-dried worms, fresh chum or dried chum, sodium-bicarbonate which may be supplied in loose or packaged form, e.g., water dissolvable capsules.

In an aspect combinable with any other aspect, buoyancy of the lure may be adjusted or may vary because the water dispersible material loses mass as the lure is drawn through the water.

In an aspect combinable with any other aspect, the body and diving bill may be plastic, wood, metal or a combination of any of the foregoing. The body may include one or more treble hooks.

### BRIEF DESCRIPTION OF THE DRAWING FIGURES

FIG. 1 shows an example implementation of a plug-type lure according to the present invention;

FIG. 2 shows the example implementation of (FIG. 1) in an open position;

FIG. 3 is a cross-sectional view taken along lines 3-3 (FIG. 1);

FIG. 4 is a cross-sectional view taken along lines 3-3 (FIG. 1) showing a cavity of the lure filled with dehydrated worms;

FIG. 5 shows the example implementation of the lure in a typical use;

FIG. 6 is a side view of second example implementation thereof;

FIG. 7 is a side view of a third example implementation thereof;

FIG. 8 is a side view of a fourth example implementation thereof.

FIG. 9 is a side view of a fifth example implementation thereof.

### REFERENCE LISTING OF THE ELEMENTS

(100) Lure
(102) body
(103) aperture
(104) closure
(105) raised annulus
(106) fin
(107a, 107b) separable portions
(108) treble hook
(110) cavity
(112) diving bill
(116) line loop
(117) simulated eye
(118) attractant material
(120) fishing line
(121) odoriferous/aromatic particles

### Definitions

In the following description, unless otherwise explained, any technical terms used herein have the same meaning as commonly understood by one of ordinary skill in the art to which this disclosure belongs. The singular terms “a”, “an”, and “the” include plural referents unless the context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” All publications, patent applications, patents, and other references listed in this disclosure are incorporated by reference in their entirety for all purposes. In case of conflict, the present specification, including explanations of terms, will control. In addition, the materials, methods, and examples are illustrative only and not intended to be limiting.

### DETAILED DESCRIPTION OF THE EMBODIMENTS

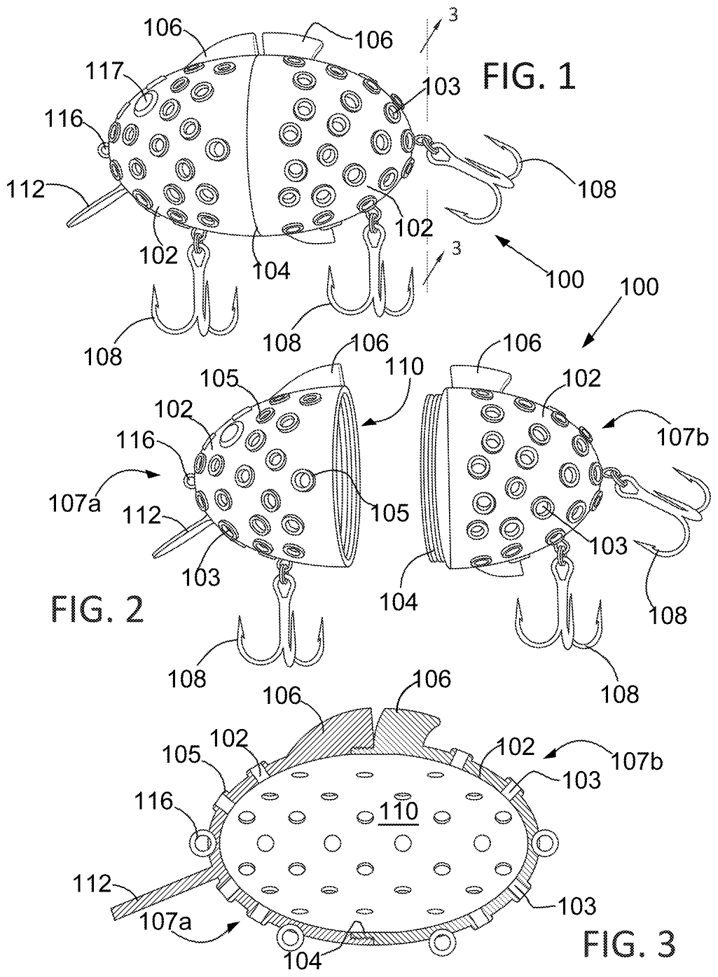

Referring generally to FIGS. 1-9, a plug-type fishing lure (100) includes a body (102) which may adopt the shape of traditional plug-type lure, may be ovoid shaped, spherical or capsule shaped. Body (102) includes at least a diving bill (112), at least one internal cavity (110) and one or more apertures (103) or passageways that pass from the at least one cavity to an exterior surface of the lure. The lure may contain one or more separable portions (107a, 107b) that are joined via a threaded connection (104) or friction fit (press-together) closure so that cavity (110) may be accessed and filled with a water dispersible material.

FIG. 1 depicts a general example implementation that includes an ovoid body (102) with a diving bill (112) that may be any size or shape, fins (106) and treble hooks attached to the rear and underside of the lure. Body (102) may include any decorative motif, markings or indicia to simulate a prey-fish, and may also include simulated eyes (117), fins, scales, spots or any other feature as desired. Apertures (103) may be formed in the body (102) in a random or regular, e.g., concentric, radial or spiral pattern. In some cases, apertures (103) may be surrounded by raised annuli (105) that are contrastingly colored.

FIG. 2 shows the implementation of (FIG. 1) where separable portions (107a, 107b) have been separated to reveal a cavity (110) adapted to receive and temporarily house a quantity of a material attractant that may be freeze-dried worms, fresh or dried chum or compressed sodium-bicarbonate, e.g., tablets. Apertures (103) communicate with cavity (110) such that the material attractant of whatever composition is exposed to moisture as the lure is drawn through water by a line (FIG. 5) whereby constituents of the material pass through the apertures and are externalized in the body of water in the wake of the lure. In the case of compressed sodium-bicarbonate, the release of CO₂ gas when the bicarbonate is exposed to water causes the lure to bob up and down and release bubbles that are attractive to fish. In the case of freeze-dried worms or chum, odoriferous particles (121) attractive to many species of fish are produced and dispersed in the wake of the lure as it is drawn through the water. It should be understood that while the particular implementations shown separate generally in the middle, any of the lures shown may include alternative resealable ports at any location on the lure body whereby bait material is introduced into the lure body.

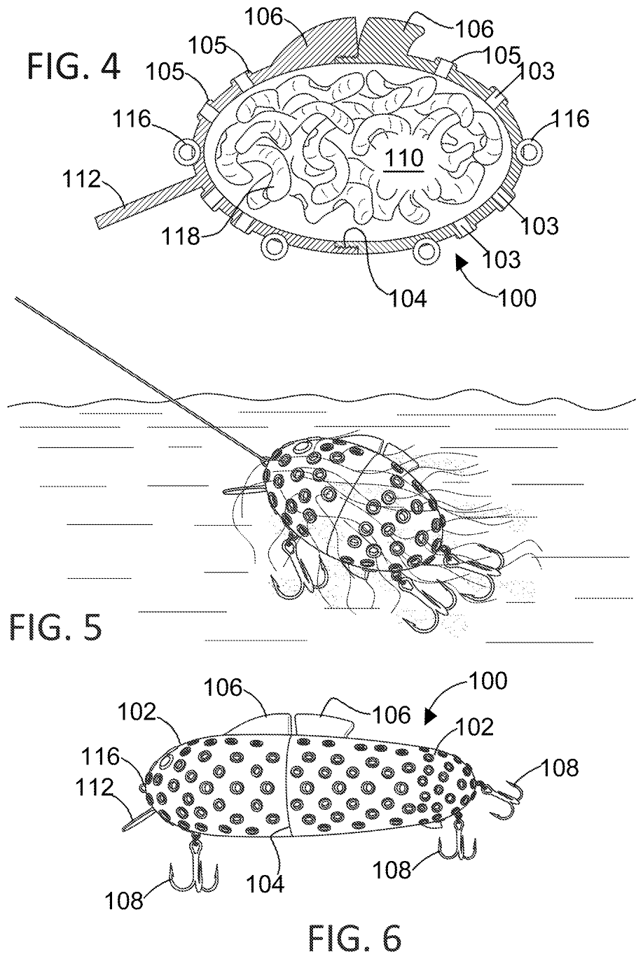

FIG. 4 is a cross-sectional view of the implementation shown in (FIG. 1) that shows internal cavity (110) filed with freeze-dried worms. Although closure (104) is shown as threaded, a friction fit whereby the separable portions (107a, 107b) are secured together by friction fit, a magnetic coupling or any other method of securing the portions together may be used. Furthermore, diving bill (112) may be formed at any suitable angle for shallow or deep diving purposes. In some implementations, the angle of diving bill (112) may be adjustable.

FIG. 6 shows an implementation having a different form factor than (FIG. 1), being somewhat elongate and tapering at the ends.

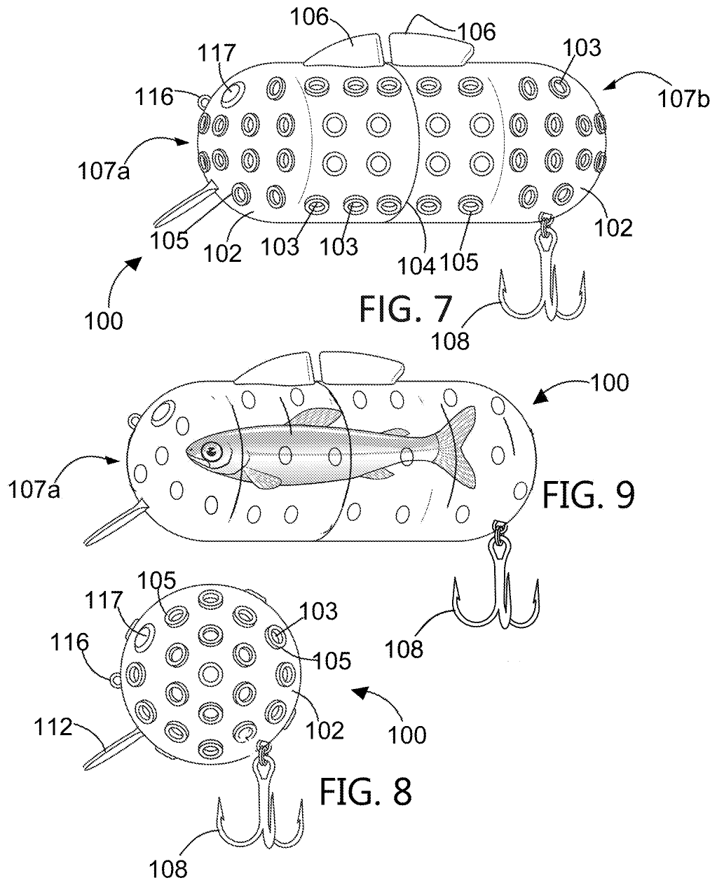

FIG. 7 shows a non-tapering capsular implementation and FIG. 8 shows a spherical implementation.

FIG. 9 is another implementation showing a transparent or translucent plug lure wherein a live minnow, tadpole or frog has been placed within. Movement of the live bait is natural and acts as yet another attractant to game fish. Moreover, it is possible that the bait remain unharmed as it is protected within the lure body which has apertures to permit the free flow of water into and out of the body. The lure body may be translucent or transparent the apertures may be relatively evenly spaced, randomly spaced or localized at the front, rear or middle or any combination thereof. Portions of the body may include lens-shaped portions (not shown) that magnify live bait movement.

Advantageously, implementations described herein allow the insertion of many attractants of various kinds inside the lure body. For example, chopped up worms, meat, peanut butter, dough bait, blood bait, insects such as dried or live crickets or live bait such as minnows and frogs may be utilized by users as desired allowing for ad hoc experimentation.

In any of the described implementations, as will be appreciated by those skilled in the art, luminescent material, reflective materials or other visually stimulating elements may be added.

Accordingly, it is intended that this disclosure encompass any further modifications, changes, rearrangements, substitutions, alternatives, design choices, and embodiments as would be appreciated by those of ordinary skill in the art having benefit of this disclosure, and falling within the spirit and scope of the following claims.

What is claimed is:

1. A buoyant plug-type fishing lure comprising:
a body including an open position and a closed position, the body includes a front side and a back side, an outer surface, at least one separable portion adapted to enclose at least one cavity, the cavity adapted to contain a material, and, the outer surface further includes apertures that form passageways to the at least one cavity;
a bill attached to the front side;
one or more treble hooks affixed to the outer surface.

2. The plug-type fishing lure according to claim 1 wherein the material is water dispersible.

3. The plug-type fishing lure according to claim 1 wherein the body has a variable buoyancy.

4. The plug-type fishing lure according to claim 1 further comprising an aromatic material.

5. The plug-type fishing lure according to claim 1 further comprising a water activated material.

6. The plug-type fishing lure according to claim 1 wherein the body is translucent such that contents of the cavity may be readily viewed when the body is closed.

7. The plug-type fishing lure according to claim 1 adapted for shallow diving or deep diving.

8. A buoyant plug-type fishing lure comprising:
a lure body including a cavity adapted to contain a bait material, an inner surface of the cavity, an outer surface including plural passageways adapted to extend into the inner cavity, the lure body includes a loading port adapted to receive the bait material;
a bill attached to the front side;
one or more treble hooks affixed to the outer surface.

9. The plug-type fishing lure according to claim 8 wherein the material is water dispersible.

10. The plug-type fishing lure according to claim 8 wherein the body has a variable buoyancy.

11. The plug-type fishing lure according to claim 8 further comprising an aromatic material.

12. The plug-type fishing lure according to claim 8 further comprising a water activated material.

13. The plug-type fishing lure according to claim 8 wherein the body is translucent such that contents of the cavity may be readily viewed when the body is closed.

14. The plug-type fishing lure according to claim 8 adapted for shallow diving or deep diving.

15. A method of bait loading a fishing lure comprising the steps of:
providing a plug-type fishing lure the lure including:
a translucent body including a cavity adapted to contain a bait material, an inner surface of the cavity, an outer surface including plural passageways adapted to extend into the inner cavity, the lure body includes a loading port adapted to receive the bait material;
a bill attached to the front side;
one or more treble hooks affixed to the outer surface; and
introducing live bait into the cavity via the loading port.
